(19) United States
(12) Patent Application Publication
(10) Pub. No.: US 2018/0302189 A1
(43) Pub. Date: Oct. 18, 2018

(54) RELIABLE COMMUNICATION ALGORITHM FOR WIRELESS MEDICAL DEVICES AND SENSORS WITHIN MONITORING SYSTEMS

(71) Applicant: KONINKLIJKE PHILIPS N.V., EINDHOVEN (NL)

(72) Inventors: John Price HARROD IV, NORTH ANDOVER, MA (US); Brian ROSNOV, MELROSE, MA (US)

(21) Appl. No.: 15/766,875

(22) PCT Filed: Oct. 25, 2016
(86) PCT No.: PCT/EP2016/075637

§ 371 Date: Apr. 9, 2018

Related U.S. Application Data
(60) Provisional application No. 62/248,043, filed on Oct. 29, 2015.

(51) Int. Cl. H04L 1/08; H04L 12/26; H04L 29/08

(52) U.S. Cl. CPC H04L 1/08; H04L 43/16; H04L 67/12; H04L 69/324; H04L 43/0829

(57) ABSTRACT

A wireless medical device (10) includes at least one physiological sensor (12) configured to measure a vital sign or a physiological parameter data and a wireless transceiver (24). At least one processor (22, 24, 34) is programmed to: construct a data stream comprising a sequence of data packets, the data packets containing physiological parameter data acquired by the at least one physiological sensor; operate the wireless transceiver to transmit the data stream to an associated monitoring station (14) via a wireless communication channel (18); receive a gap report from the associated monitoring station identifying at least one missing data packet of the data stream that was not received at the associated monitoring station; and re-transmit the at least one missing data packet identified by the gap report to the associated monitoring station via the wireless communication channel.

### FIELD

The following relates generally to the medical monitoring and therapy arts, data transmission arts, and related arts.

### BACKGROUND

In recent years medical devices are becoming more connected to larger systems via computer networks, including wireless technology such as IEEE 802.11. As networking and wireless technology becomes more complex and spectrum congested, there is a higher likelihood that errors can occur which will negatively impact the quality of the application-level data sent by wireless medical devices. To overcome these risks, application level mechanisms need to be implemented that reduce user-perceived data loss and to ensure that a complete patient record is collected in a timely manner. For example, packets of data may become lost, held up, and/or corrupted during data transfer between the wireless medical device and larger systems. The reasons data packets fail to complete a successful transmission over wireless networks are numerous and include RF interference, poor signal strength or signaling conditions, network issues at the IP or MAC layers, radio errors, defects in the infrastructure technology, congestion, and media contention.

Existing WiFi systems provide multiple network protocol stack layers, including a Media Access Control (MAC) layer and IP layer, some of which do provide for re-transmission of lost packets. However, many layers operate without memory, that is, they will attempt to retransmit the current packet until a maximum number of attempts is reached, and do not attempt to re-transmit “old” packets when bandwidth is available. These layers are also payload-agnostic and cannot reconstruct packets to enable re-transmission. Other network layers that do provide “memory” for connection oriented retransmission of data packets (ie. TCP)do so without consideration of the potential time criticality of the retransmission of a particular application layer service and without consideration of the physical layer bandwidth availability, retransmission timeliness, and retransmission impact on “current” packet throughput.

Loss of data packets is also made more likely when using a wireless communication channel such as an IEEE 802.11 that employs “break-before-make” roaming. In such a wireless communication channel, a mobile device switches from one wireless access point (WAP) to another WAP by disconnecting (“breaking”) from the one WAP before connecting with the next WAP. This introduces a potential data discontinuity between the breaking of the first connection and the making of the next connection. For IEEE 802.11 channels, the interval between breaking connection with one WAP and making connection with the next WAP can be up to 90 seconds, which equates to hundreds or more data packets.

Data packet buffering may be unable to cope with such communication channel breaks, especially in low-power wireless medical monitoring devices that may have limited data buffering capacity and may have end to end maximum time restrictions for data delivery. While data loss during roaming events may be acceptable for some types of communication, they are not acceptable when the data stream is conveying real-time life-critical physiological parameter data (e.g. heart rate data, respiratory rate data, capnography data, or so forth). Such problems have hindered migration of life-critical patient monitoring data communications from high-cost and limited bandwidth dedicated wireless communication channels to lower cost and higher bandwidth general-purpose WiFi or other general-purpose wireless communication channels.

The following discloses a new and improved systems and methods that address the above referenced issues, and others.

### SUMMARY

In one disclosed aspect, a wireless medical device includes at least one physiological sensor configured to measure a vital sign or a physiological parameter data and a wireless transceiver. At least one processor is programmed to: construct a data stream comprising a sequence of data packets, the data packets containing physiological parameter data acquired by the at least one physiological sensor; operate the wireless transceiver to transmit the data stream to an associated monitoring station via a wireless communication channel; receive a gap report from the associated monitoring station identifying at least one missing data packet of the data stream that was not received at the associated monitoring station; and re-transmit at least one missing data packet identified by the gap report to the associated monitoring station via the wireless communication channel.

In another disclosed aspect, a non-transitory storage medium stores instructions readable and executable by one or more microprocessors to perform a method. The method includes constructing a data stream comprising a sequence of data packets, the data packets containing physiological parameter data acquired by at least one physiological sensor; transmitting the data stream to an associated monitoring station via a wireless communication channel; receiving a gap report from the associated monitoring station identifying at least one missing data packet of the plurality of data packets that was not received at the associated monitoring station; and re-transmitting the at least one missing data packet identified by the gap report to the associated monitoring station via the wireless communication channel.

In another disclosed aspect, a patient monitoring apparatus includes a wireless medical device configured to acquire physiological parameter data and construct and transmit a data stream comprising of a sequence of data packets containing the acquired physiological parameter data. A monitoring station includes a wireless transceiver. At least one electronic processor is programmed to: operate the wireless transceiver to receive the data stream from the wireless medical device via a wireless communication channel; detect at least one missing data packet in the received data stream; generate a gap report identifying the at least one missing packet; and operate the wireless transceiver to transmit the gap report to the wireless medical device via the wireless communication channel. A display component is configured to display the physiological parameter data contained in the data packets of the data stream with a placeholder indicative of the at least one missing data packet.

One advantage resides in re-transmitting missing data packets from a data stream to avoid data lose.

Another advantage resides in facilitating reliable communication of life-critical patient data over a general-purpose wireless communication network.

Another advantage resides in facilitating reliable communication of life-critical patient data over a WiFi or other wireless network that employs break-before-make roaming.

Another advantage resides in re-creating missing data stream packets, which delivery to the monitoring system may be time critical, from acquired vital sign data.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 diagrammatically illustrates a patient monitoring apparatus for wirelessly monitoring a patient as disclosed herein.

FIG. 2 diagrammatically illustrates a display showing data from the patient monitoring apparatus of FIG. 1.

FIG. 3 is a flow chart showing an exemplary method of use for the apparatus of FIG. 1.

### DETAILED DESCRIPTION

This disclosure presents a mechanism for backfilling physiological data when segments of the data are lost or corrupted within a wireless patient monitoring system. Often, wireless medical devices transmit life-critical patient data, and therefore, reliability is paramount. One way to enhance reliability is to employ dedicated spectrum for the wireless medical devices , however there is an industry interest in having these devices operate within available wireless networks owned or utilized by healthcare providers and patient (e.g., WiFi, cellular, Bluetooth® Low Energy (BLE), etc.). Operating in available, general purpose wireless networks increases the potential for data loss from the wireless medical device, but on the other hand bandwidth available to each device increases compared with a typically narrow-band or dedicated spectrum patient monitoring system channel (i.e. wireless medical telemetry service (WMTS)).

In approaches disclosed herein, the higher bandwidth is leveraged to improve reliability by re-transmitting any lost data packets so as to reconstitute the complete acquired physiological sensor data and analysis at the monitoring station (e.g. a nurses' station, bedside patient monitor, central electronic medical record network server computer, or other monitoring station). To this end, the monitoring station transmits back a “gap report” identifying any lost data by packet sequence number or by the time interval of the missing patient data. The wireless medical device then uses any available bandwidth to re-transmit (i.e. “backfill”) the lost data within a specified period of time, in order to maintain any alarming claims of the monitoring system. An algorithm or module helps reduce or eliminate the amount of data lost at the monitoring station by providing a method to fill in missing gaps.

In one approach, the backfill operates by re-transmitting data packets that are buffered at the wireless medical device. Missing packets are identified by packet sequence number, and the wireless medical device re-transmits the missing packets. This approach is efficient, but the packets must be stored, as packets, at the wireless medical device, possibly along with the same data stored as raw patient waveform data thus requiring “double storage” of the same data.

In another approach, the backfill operates on the sensor data. In this instance, gaps are identified by time intervals of missing sensor data , and the wireless medical device re-constructs the packet corresponding to the missing time intervals in order to re-transmit it.

An advantage is that there is no need to store the packetized data, thus avoiding the disadvantage of storing both the raw data and packetized versions of the same data.

A hybrid approach also disclosed herein operates in packet space to backfill missing data over a short time interval, e.g. a few seconds or a few minutes. For longer time intervals, operation in data space with packet reconstruction would be employed. This enables using the more efficient packet space implementation for occasional lost data packets with a relatively small packet buffer at the wireless medical device, while being able to re-transmit longer missing intervals (say, due to the patient being moved outside range of the monitoring station for an extended time period) using re-construction of packets, albeit at increased computational cost.

Another aspect of the backfill concept is that the backfilled data may optionally be tagged as such in a display or storage database of the data at the monitoring station or system. The tagging may consist of highlighting backfilled data by a special color or the like. Although the backfilled data are expected to be of the same reliability as originally-transmitted data, such highlighting may be useful to inform nurses if they initially note the trace or patient record has such missing data which is then added, and may be useful for auditing purposes, particularly during the review of sentinel events. As used herein, the term “sentinel events” (and variants thereof) refers to an unexpected occurrence involving death, serious physical or psychological injury (e.g., heart attack, cardiac arrest, stroke, paralysis, and the like), or the risk thereof

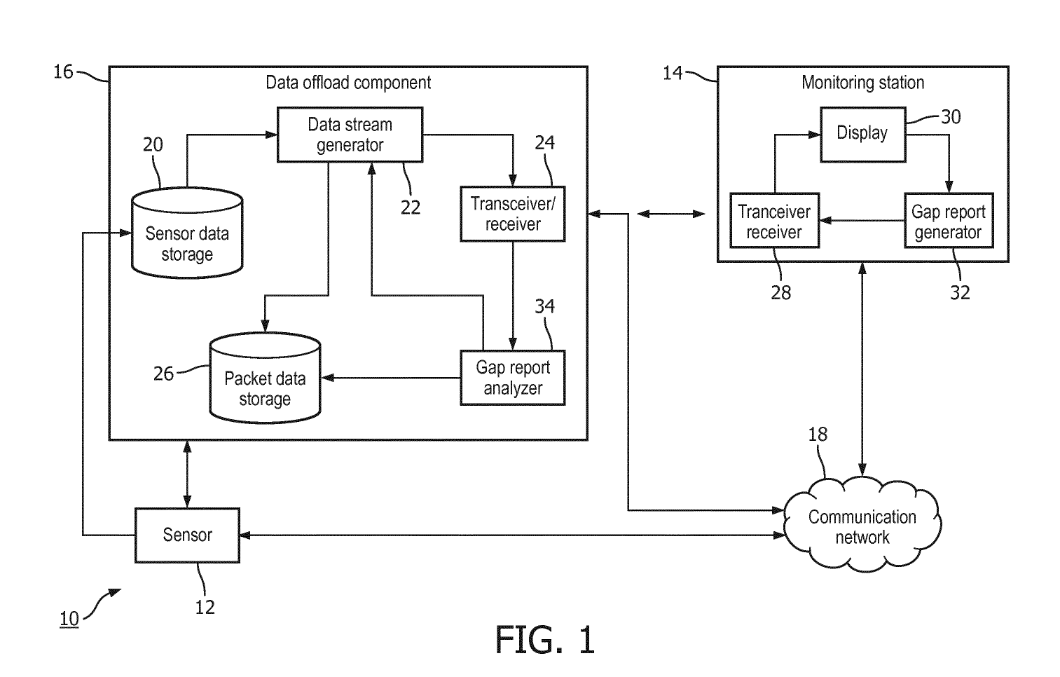

With reference to FIG. 1, an exemplary embodiment of a patient monitoring device or apparatus 10 (more generally, a wireless medical device 10) is shown. The wireless medical device 10 may, for example, be a Philips Intellivue™ MX40 ambulatory patient monitor available from Koninklijke Philips N.V., Eindhoven, the Netherlands, or may be another commercial or custom-built patient monitoring device or the like. The wireless medical device 10 is wireless, so that it is in wireless communication with one or more remote computer systems (more generally, a monitoring station), as described in more detail below. Advantageously, the wireless medical device 10 includes one or more components that: (1) receives from a wirelessly connected monitoring station an identification of any lost data by packet sequence number or by the time interval of the missing patient data (that is, receives a “gap report”); and (2) uses any available bandwidth to re-transmit the lost data to the monitoring station.

As shown in FIG. 1, the wireless medical device 10 includes or is operatively connected with at least one physiological sensor 12. The wireless medical device 10 is wirelessly connected with a patient monitoring station 14 by a data offload component 16 of the wireless medical device 10 that includes one or more electronics. The physiological sensor 12 can be any suitable sensor, such as a heart rate sensor, a respiratory sensor, an accelerometer, a thermometer, a pressure sensor, an electrocardiograph, a pulse oximeter, a blood pressure monitor, any non-invasive or invasive physiological sensor, and the like. The physiological sensor 12 can be physically connected to the data offload component 16 (i.e., via a USB cable or a cord and a corresponding port), or electronically via a short-range wireless communications link (e.g., BLE) or an integrated circuit within or electrically connected to the data offload component 16. The physiological sensor 12 is configured to measure physiological parameter data such as vital sign data (e.g., heart rate, blood oxygen saturation levels, blood pressure, respiratory rate, body temperature, and the like) or any other physiological parameter data (e.g., patient movement, patient acceleration, and the like) of a patient. This data is transmitted from the physiological sensor 12 to a sensor data storage 20 of the data offload component 16. In some embodiments, the physiological sensor 12 can send the data to a sensor sample and processor (not shown) that performs signal processing on the data (e.g., filtering, normalization, algorithmic analysis and analytics, alarm detection and generation and the like), and then transfers this processed data to the sensor data storage 20.

The monitoring station 14 is configured to receive physiological parameter data and analysis from the wireless medical device 10 via a wireless communication channel 18, and optionally also to display information obtained by the physiological sensor 12 and the wireless medical device 10. For example, the monitoring station 14 can be a bedside patient monitor, a computer or workstation located a suitable location, such as a nurses' station or a doctor's office, a mobile tablet, a, phone, another mobile computing platform utilized by caregivers, or so forth. In other embodiments, the monitoring station 14 may be an Electronic Medical Record (EMR) network server that collects physiological data, analysis and analytics for patients and stores the data in appropriate patient EMR files, but does not immediately display the data, or may immediately transfer the data to a nurses' station for display or so forth. As discussed in more detail below, the monitoring station 14 is configured to receive a data stream from the data offload component 16 of the wireless medical device 10.

The data offload component 16 includes a data stream generator 22 that is programmed to construct a data stream comprising a sequence of data packets. The data packets contain physiological data, information and analysis acquired by the physiological sensor 12 and the wireless medical device 10. The data stream generator 22 retrieves the physiological data, information and analysis from the sensor data storage 20. From this data, the data stream generator 22 constructs or otherwise generates a data stream of the physiological data, information and analysis. For example, the data stream generator 22 can create a data stream of heart rate data, electrocardiogram (ECG) waveforms, arrhythmia analytics and cardiac related alarms that is retrieved from the data stream storage 20. The data packets of the sequence of data packets may be explicitly labeled with sequence numbers, or the sequence may be implicit in the ordering. Explicit labeling of each data packet with a sequence number (e.g. an 8-bit, 16-bit, 32-bit, or 64-bit sequence number in some embodiments) is advantageous to reduce the likelihood if failing to identify a missing data packet. However, it is alternatively contemplated to rely upon the order of transmission of data packets, so that a missing data packet is identified as a time gap in the transmission sequence. Once the data stream is generated, the data stream generator 22 operates a wireless radio transceiver 24 to transmit the data stream to the monitoring station 14 via the wireless communication channel 18. In addition, in some embodiments the data stream generator 22 transmits the data packets of data to a packet database 26. The packet database 26 is configured to store the last “N” transmitted data packets of the data stream. The number of stored data packets N is an integer that is at least two.

At the monitoring station 14, a radio transceiver 28 receives the data stream from the corresponding transceiver 24 of the data offload component 16 via the wireless communication channel 18. The transceiver 28 then transfers the data stream to a display 30 of the monitoring station 14, where a medical professional (e.g., a nurse, a doctor, and the like) can see and review the visualization and representation of the data stream. (Alternatively, depending on the type of the monitoring station 14, the data may be otherwise utilized, e.g. stored in an EMR file in the case of a monitoring station comprising an EMR server). The transceiver 28 also sends the data stream to a gap report generator 32 of the monitoring station 14. The gap report generator 32 analyzes the data stream received at the monitoring station 14 to see if any data packets are missing therefrom. If the gap report generator 32 determines that one or more data packets are missing from the data stream, the gap report generator 32 then generates a gap report stating which packets are missing. If the data packets are explicitly labeled with sequence numbers, then a missing data packet can be readily identified as a missing sequence number in the data stream. If no explicit sequence number labeling is used then a missing data packet is identified based on a time gap, e.g. if data packets are sent at a rate of one packet every 100 msec then a time gap of 200 msec between received packets indicates a missing data packet. In either approach, a missing packet may also be identified as a packet that is received but is corrupted and hence unreadable. Further, each data packet may be labeled with a CRC number or other error-detecting code, and if the packet contents fail to match the error-detecting code then the data packet is assumed to be corrupted and is discarded—this is again a missing data packet since it was not successfully received at the monitoring station 14. The gap report suitably identifies any missing packet by the (missing) sequence number label, or by its (missing) location in the ordered sequence of data packets. Various approaches can be used, e.g. identifying each missing data packet by its individual sequence number, or (in the case of a contiguous group of missing packets) identifying the sequence number of the first data packet and a count of the number of missing data packets of the contiguous sequence. The latter approach entails transmitting less data in the gap report in the case of a long contiguous sequence of missing data packets such as may occur when the wireless communication channel 18 has a data discontinuity of several seconds.

The gap report is sent periodically, with the time interval between successive gap report transmissions chosen to balance how frequently the wireless medical device 10 is updated with missing data packet information against bandwidth of the communication channel 18 used in transmitting the gap reports. In some designs, the period between successive gap report transmissions may be greater than the number of data packets that are stored at the wireless medical device—in such a case, the wireless medical device 10 suitably indicates via an initial transmission to the monitoring station 14 how many packets it stores, and each gap report then only goes back that far (since earlier-sent packets cannot be re-transmitted as they are no longer stored at the wireless medical device 10).

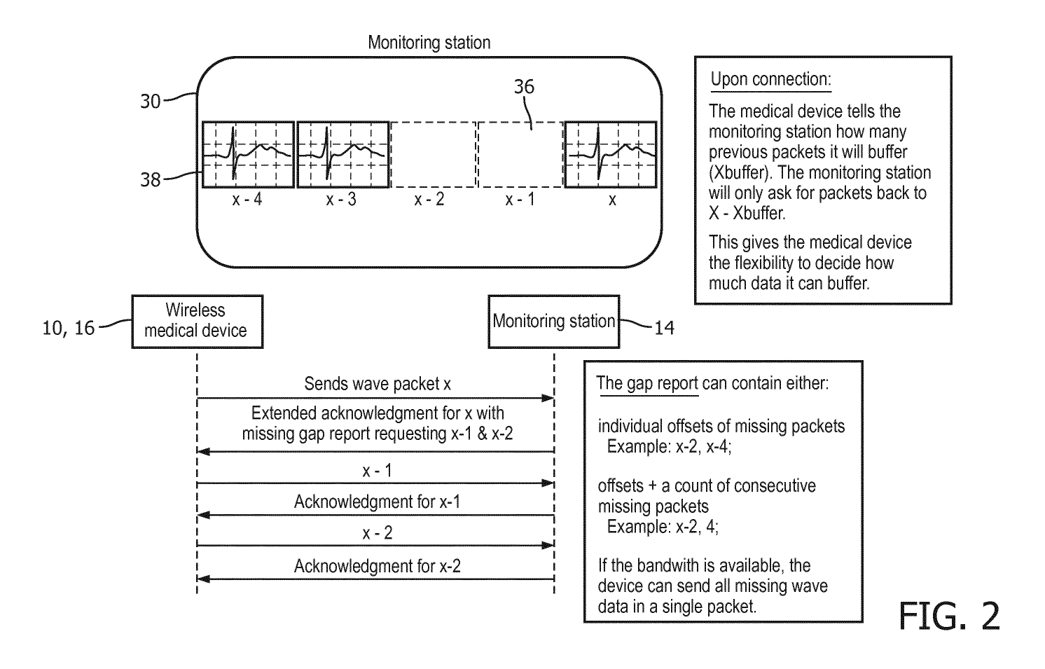

The data stream may be displayed on the display 30 as a trend line representing the vital sign data contained in the data packets of the data stream with a placeholder indicative of the at least one missing data packet. As shown in FIG. 2, the data stream is displayed with “x”—“x-4” number of packets (i.e., 5 packets). (The data packets are delineated in illustrative FIG. 2 for illustration, but typically the trend line displayed on the display 30 will not delineate the transmission data packets, but rather will show a continuous trend line except for the placeholders for missing data). The received packets 36 (i.e., the packets showing graphical data) are labeled “x-4;” “x-3;” and “x” The packets labeled “x-2” and “x-1” (i.e., packets 3 and 4) are shown as missing, and placeholders 38 (shown schematically as dashed boxes) are inserted into the data stream for the missing packets. Optionally, the gap report also includes an acknowledgment status for each received packet (i.e., the packets labeled “x-4;” “x-3;” and “x” include an acknowledgement report that they have been received by the monitoring station 14. Although FIG. 2 shows that wireless, continuous, real-time ECG monitoring system is used, it will be appreciated that the apparatus 10 can include any continuous or non-continuous physiological sensor, whose wireless communication may or may not be time critical in nature.

The transceiver 24 of the data offload component 16 is configured to receive the gap report from the transceiver 28 of the monitoring station 14. As discussed above, the gap report identifies at least one missing packet of the plurality of packets that was not received at the monitoring station 14. The gap report is then transmitted to a gap report analyzer 34 of the data offload component 16. The gap report analyzer 34 reads/analyzes the gap report to determine the missing data packets, and transmits an identification of the missing data packets to the data stream generator 22.

In one embodiment, when the data stream generator 22 receives the gap report analysis report from the gap report analyzer 34, the data stream generator 22 retrieves the physiological parameter data contained in the at least one missing data packet from the sensor data storage 20. In this example, the missing data are identified by time intervals of missing waveform. Advantageously, in this example, there is no need to store packets of data (i.e., the packet data storage 26 is omitted); thus, there is no need to store both the raw data and packetized data. The data stream generator 22 reconstructs a new data stream from the vital sign data. The new data stream: (i) only includes the missing packets of data; or (ii) includes the original data stream along with the missing data packets. The data stream generator 22 then transmits the new data stream to the transceiver 24, where it is re-transmitted to the monitoring station via the network 18.

In another embodiment, when the data stream generator 22 receives the gap report analysis report from the gap report analyzer 34, the data stream generator 22 retrieves the missing packet(s) from the packet data storage 26. The missing packets are identified by packet sequence number. In this example, the data packets must be stored at in the packet data storage 26 as well as in the sensor data storage 20. The data stream generator 22 resends the missing data packets retrieved from the packet data storage 26. This re-transmission data stream: only includes the missing packets of data. The data stream generator 22 then transmits the re-transmission data stream to the transceiver 24, where it is re-transmitted to the monitoring station 14 via the wireless communication channel 18.

In a hybrid embodiment, the packet data storage 26 stores a relatively short interval of data packets, i.e. the last N transmitted data packets. If a missing data packet lies within those N last transmitted data packets then they are retrieved from the packet data storage 26. If a missing data packet was sent some time earlier such that it is not one of the last N transmitted data packets, then its data are retrieved from the sensor data storage 20 and the data packet is re-constructed. This approach allows for efficient re-transmission of the occasional missing data packet, particularly if used within time critical application level services within the monitoring system, by retrieving it from the packet data storage 26, while still enabling re-transmission of missing data packets that were sent too long ago to still be in the packet data buffer storage 26 by the more computationally costly approach of reconstructing the data packet from the sensor data in the sensor data storage 20.

The re-transmitted data stream is received by the transceiver 28 of the monitoring device 14. In the same manner as described previously, the transceiver 28 sends the re-transmitted data stream to the display 30 and the gap report generator 32. If the gap report generator 32 determines that data packets are still missing from the data stream, the gap report generator 32 generates a gap report to be sent to the data offload component 16 (as described previously).

In addition, upon receipt of the re-transmitted data stream with at least one missing packet at the monitoring station 14, the placeholders 36 shown in the display 30 are replaced with the trend line portion of the trend line representing the data contained in the re-transmitted data stream at least one missing packet. Referring to FIG. 2, the new data stream with the packets 36 for the “x-2” and “x-1” portions replace the placeholders 38. In other words, the dashed boxes shown in FIG. 2 are replaced with the physiological data contained in the re-transmitted (and hence no longer missing) data packets. In some embodiments, the trend line portion of the trend line representing the data contained in the re-transmitted data stream with at least one missing packet is displayed visually distinguishable from the remainder of the trend line. For example, the packets for the “x-2” and “x-1” portions of the data stream can be displayed or highlighted in a different color (i.e., yellow) from the already-displayed data packets (i.e., white). It will be appreciated that any color combination for the originally transmitted packets and the re-transmitted packets can be used to allow the medical professional to distinguish the two groups of data packets. In another example, the displayed data packets can be tagged as “original” or “re-transmitted.” This feature may be useful to inform the medical professionals if they initially note the trace has such missing data which is then added, and may be useful for auditing purposes, particularly in the review of sentinel events.

In some embodiments, the transceiver 24 of the data offload component 16 is configured to determine if available bandwidth (e.g. measured in bits/second) of the wireless communication channel 18 is equal to, exceeds, or under-runs a pre-determined threshold level for determining the optimal re-transmission procedure. For example, if the available bandwidth is equal to or exceeds the pre-determined threshold level, then the transceiver 24 transmit the new data stream that includes all missing data packets simultaneously. However, if the available bandwidth under-runs the pre-determined threshold level, then the transceiver 24 transmits the new data stream that includes all missing data packets sequentially (i.e., 1 or 2 packets at a time). Alternatively, the transceiver 28 of the monitoring station 14 can operate in a similar manner when sending the gap report to the data offload component 16 (i.e., sending the gap report that includes all missing data packets, or multiple reports indicative of one missing packet at a time, and the like). In addition the transceivers 24 and 28 can include buffering components (not shown) to increase the efficiency of the data stream/gap report transmissions.

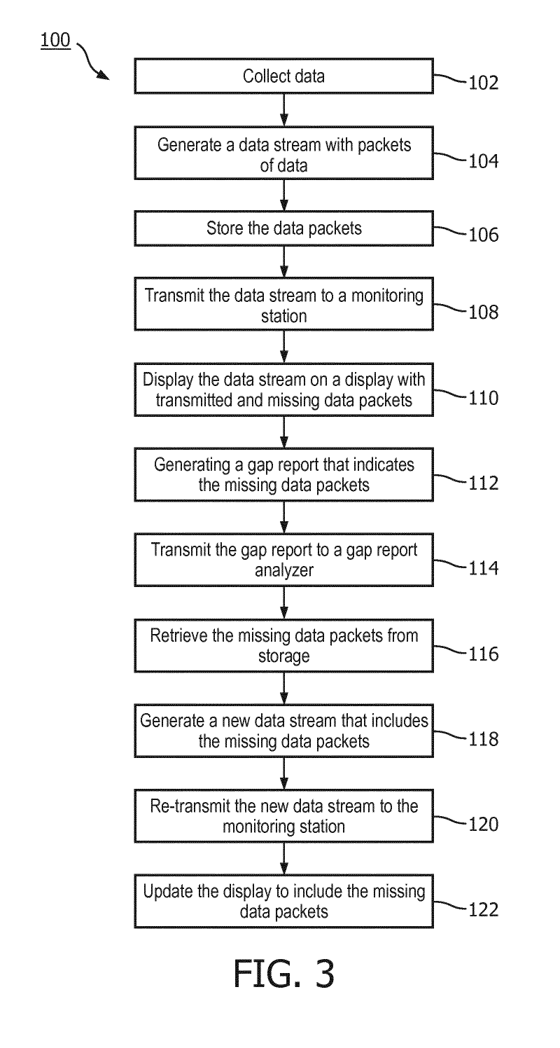

FIG. 3 shows an exemplary flow chart of a method 100 of using the patient monitoring device 10. The method 100 includes the steps of: collect at least one data indicative of a vital sign of a patient from at least one physiological sensor 12 (Step 102); generate a data stream including packets of data of the vital sign of the patient (Step 104); store the data packets in at least one storage 20, 26 (Step 106); transmit the data stream to a monitoring station 14 (Step 108); display the data stream on a display 22 that shows any transmitted data packets and any missing data packets (Step 110); generate a gap report that indicates the missing data packets (Step 112); transmit the gap report to a gap report analyzer 34 (Step 114); retrieve the missing data packets from the at least one storage (Step 116); generate a new data stream that includes the missing data packets (Step 118); re-transmit the new data stream to the monitoring station (Step 120); and update the display to include the missing data packets (Step 122).

The various data processing components 16, 22, 32, and 34 are suitably implemented as a microprocessor programmed by firmware or software to perform the disclosed operations. In some embodiments, the microprocessor is integral to the monitoring station 14 and/or the data offload component 16, so that the data processing is directly performed by the patient monitoring device 10 and/or to monitoring station 14 and/or the data offload component 16. In other embodiments the microprocessor is separate from the patient monitoring device 10, for example being the microprocessor of a desktop computer. In another embodiment, the microprocessor is integral to the sensor 12, for example an ECG acquisition sensor with integrated microprocessor for analysis. In another embodiment, the microprocessor is integral to the transceiver 24 within the patient monitoring device 10, for example an Internet of Things (IoT) low-power WiFi module such as the QCA4004. The various data processing components 16, 22, 32, and 34 of the patient monitoring device 10 may also be implemented as a non-transitory storage medium storing instructions readable and executable by a microprocessor (e.g. as described above) to implement the disclosed operations. The non-transitory storage medium may, for example, comprise a read-only memory (ROM), programmable read-only memory (PROM), flash memory, or other repository of firmware for the patient monitoring device 10. Additionally or alternatively, the non-transitory storage medium may comprise a computer hard drive (suitable for computer-implemented embodiments), an optical disk (e.g. for installation on such a computer), a network server data storage (e.g. RAID array) from which the patient monitoring device 10 or a computer can download the system software or firmware via the Internet or another electronic data network, or so forth. In addition, at least one of the sensor data storage 20 and the packet data storage 26 can be stored in a volatile memory, such as a random access memory (RAM), a buffered RAM, and the like. For a buffered RAM memory, the data stored in the sensor data storage 20 and/or the packet data storage 26 can remain intact over reboots and/or power cycling of the patient monitoring device 10.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A wireless medical device, comprising:
at least one physiological sensor configured to measure physiological parameter data;
a wireless transceiver; and
at least one electronic processor programmed to:
construct a data stream comprising a sequence of data packets, the data packets containing physiological parameter data acquired by the at least one physiological sensor;
operate the wireless transceiver to transmit the data stream to an associated monitoring station via a wireless communication channel;
receive a gap report from the associated monitoring station identifying at least one missing data packet of the data stream that was not received at the associated monitoring station; and
re-transmit the at least one missing data packet identified by the gap report to the associated monitoring station via the wireless communication channel
wherein the transceiver is configured to perform break-before-make roam events between wireless access points (WAP's) in which the transceiver disconnects from one WAP before connecting to another WAP producing a data discontinuity in the wireless communication channel during a time interval between the disconnection and the connection.

2. (canceled)

3. The wireless medical device according to claim 1, wherein the electronic processor is programmed to re-transmit the at least one missing data packet by:
re-transmitting all missing data packets simultaneously when an available bandwidth of the wireless communication channel is equal to or exceeds a pre-determined threshold level.

4. The wireless medical device according to claim 1, wherein the electronic processor is programmed to re-transmit the at least one missing data packet by:
re-transmitting the missing data packets successively when an available bandwidth of the wireless communication channel under-runs a pre-determined threshold level.

5. The wireless medical device of claim 1 further comprising:
a sensor data storage configured to store the physiological parameter data acquired by the at least one physiological sensor; and
wherein the re-transmit operation includes:
retrieving the physiological parameter data contained in the at least one missing data packet from the sensor data storage;
reconstructing the at least one missing data packet from the retrieved vital sign data; and
transmitting the reconstructed at least one missing packet to the associated monitoring station via the wireless communication channel.

6. The wireless medical device of claim 1 further comprising:
a packet data storage configured to store the data packets of the data stream;
wherein the re-transmit operation includes:
retrieving the at least one missing packet from the packet data storage; and
transmitting the at least one missing packet retrieved from the packet data storage to the associated monitoring station via the wireless communication channel

7. The wireless medical device of claim 1 further comprising:
a sensor data storage configured to store the physiological parameter data acquired by the at least one physiological sensor;
a packet data storage configured to store the last N transmitted data packets of the data stream where N is an integer greater than or equal to two;
wherein the re-transmit operation includes:
retrieving any missing packet which is among the last N transmitted data packets from the packet data storage;
retrieving the physiological parameter data contained in any missing data packet that is not among the last N transmitted data packets from the sensor data storage and reconstructing the missing data packet from the retrieved vital sign data; and
transmitting the retrieved or reconstructed at least one missing packet to the associated monitoring station via the wireless communication channel.

8. A medical monitoring system comprising:
a wireless medical device as set forth in claim 1 wherein the at least one electronic processor is programmed to construct the data stream comprising the sequence of data packets with each data packet including a sequence number; and
monitoring station including a transceiver configured to receive the data stream via the wireless communication channel and a gap report generator comprising an electronic processor programmed to (i) detect a missing data packet in the data stream received at the monitoring station based on a gap in the sequence numbers of the data packets of the received data stream and (ii) generate the gap report identifying any detected missing data packet of the data stream received at the monitoring station.

9. A non-transitory storage medium storing instructions readable and executable by one or more microprocessors to perform a method, comprising:
constructing a data stream comprising a sequence of data packets, the data packets containing physiological parameter data acquired by at least one physiological sensor;
transmitting the data stream to an associated monitoring station via a wireless communication channel;
receiving a gap report from the associated monitoring station identifying at least one missing data packet of the plurality of data packets that was not received at the associated monitoring station; and
re-transmitting the at least one missing data packet identified by the gap report to the associated monitoring station via the wireless communication channel
wherein the transmitting comprises:
operating a wireless transmitter to transmit the data stream to the associated monitoring station; and
during the operating, breaking connection with a first access point and, after a time interval during which the wireless communication channel is broken, making a connection with a second access point.

10. (canceled)

11. The non-transitory storage medium according to claim 9, wherein the re-transmitting comprises:
re-transmitting all missing data packets simultaneously when an available bandwidth of the wireless communication channel is equal to or exceeds a pre-determined threshold level.

12. The non-transitory storage medium of claim 9, wherein the re-transmitting comprises:
re-transmitting the missing data packets successively when an available bandwidth of the wireless communication channel under-runs a pre-determined threshold level.

13. The non-transitory storage medium of claim 9, wherein the method further comprises:
transmitting the physiological parameter data acquired by the at least one physiological sensor to a sensor data storage for storage therein; and
herein the re-transmit operation includes:
retrieving the physiological parameter data contained in the at least one missing data packet from the sensor data storage;
reconstructing the at least one missing data packet from the retrieved physiological parameter data; and
transmitting the reconstructed at least one missing packet to the associated monitoring station via the wireless communication channel.

14. The non-transitory storage medium of claim 9, wherein the method further comprises:
transmitting the data packets of the data stream to a packet data storage for storage therein;
wherein the re-transmit operation includes:
retrieving the at least one missing packet from the packet data storage; and
transmitting the at least one missing packet retrieved from the packet data storage to the associated monitoring station via the wireless communication channel.

15. The non-transitory storage medium of claim 9, wherein the method further comprises:
transmitting the physiological parameter data acquired by the at least one physiological sensor to a sensor data storage for storage therein;
transmitting the data packets of the data stream to a packet data storage for storage therein;
wherein the re-transmit operation includes:
retrieving any missing packet which is among the last N constructed data packets from the packet data storage;
retrieving the vital sign data or the physiological parameter data contained in any missing data packet that is not among the last N constructed data packets from the sensor data storage and reconstructing the missing data packet from the retrieved vital sign data; and
transmitting the retrieved or reconstructed at least one missing packet to the associated monitoring station via the wireless communication channel.

16. A patient monitoring apparatus, comprising:
a wireless medical device configured to acquire physiological parameter data and construct and transmit a data stream comprising a sequence of data packets containing the acquired physiological parameter data; and
a monitoring station comprising:
a wireless transceiver;
at least one electronic processor programmed to operate the wireless transceiver to receive the data stream from the wireless medical device via a wireless communication channel, detect at least one missing data packet in the received data stream, generate a gap report identifying the at least one missing packet, and operate the wireless transceiver to transmit the gap report to the wireless medical device via the wireless communication channel; and
a display component configured to display a trend line representing the physiological parameter data contained in the data packets of the data stream with a placeholder indicative of the at least one missing data packet.

17. The apparatus according to claim 16, wherein:
the at least one processor of the monitoring station is further programmed to operate the wireless transceiver to receive a re-transmission of the at least one missing data packet from the wireless medical device via the wireless communication channel; and
the display component is further configured to replace the placeholder with physiological data contained in the re-transmission of the at least one missing data packet.

18. (canceled)

19. The apparatus according to claim 16, wherein the at least one electronic processor of the monitoring station is programmed to detect at least one missing data packet in the received data stream based on a gap in sequence numbers of the data packets of the sequence of data packets.

20. (canceled)
